(19) United States
(12) Patent Application Publication
(10) Pub. No.: US 2018/0071674 A1
(43) Pub. Date: Mar. 15, 2018

(54) Apparatus and System for Enhanced Selective Contaminant Removal Processes Related Thereto

(71) Applicants: Stephanie A. Freeman, Houston, TX (US); Edward J. Grave, Montgomery, TX (US); J. Tim Cullinane, Montgomery, TX (US); P. Scott Northrop, The Woodlands, TX (US); Norman K. Yeh, Shenandoah, TX (US)

(72) Inventors: Stephanie A. Freeman, Houston, TX (US); Edward J. Grave, Montgomery, TX (US); J. Tim Cullinane, Montgomery, TX (US); P. Scott Northrop, The Woodlands, TX (US); Norman K. Yeh, Shenandoah, TX (US)

(21) Appl. No.: 15/652,856

(22) Filed: Jul. 18, 2017

Related U.S. Application Data
(60) Provisional application No. 62/394,489, filed on Sep. 14, 2016.

(51) Int. Cl. B01D 53/14

(52) U.S. Cl. CPC B01D 53/1412; B01D 53/1468; B01D 2252/20489; B01D 53/1493; B01D 2252/20431; B01D 53/1475

(57) ABSTRACT

Systems and methods for separating CO₂ and H₂S from a gaseous stream are provided herein. The system includes a selective solvent that is utilized with a compact contacting technology unit to remove H₂S from a gaseous stream.

### CROSS REFERENCE TO RELATED APPLICATIONS

This application claims the priority benefit of U.S. Patent Application 62/394,489 filed Sep. 14, 2016 entitled APPARATUS AND SYSTEM FOR ENHANCED SELECTIVE CONTAMINANT REMOVAL PROCESS RELATED THERETO, the entirety of which is incorporated by reference herein.

### FIELD OF THE INVENTION

The present techniques relate to a system and method associated with an enhanced selective contaminant removal process. In particular, the system and process relate to a removal process for the removing contaminants, such as hydrogen sulfide (H₂S), from a gaseous stream.

### BACKGROUND

This section is intended to introduce various aspects of the art, which may be associated with exemplary embodiments of the present techniques. This description is believed to assist in providing a framework to facilitate a better understanding of particular aspects of the present techniques. Accordingly, it should be understood that this section should be read in this light, and not necessarily as admissions of prior art.

The production of hydrocarbons from a reservoir involves the incidental production of non-hydrocarbon gases. Such non-hydrocarbon gases include contaminants, such as hydrogen sulfide (H₂S) and carbon dioxide (CO₂). When H₂S or CO₂ are produced with hydrocarbons in a production stream, the production stream may be a raw natural gas stream that may include methane and/or ethane and may be referred to as a “sour” natural gas. The H₂S and CO₂ are often referred to as “acid gases.”

Sour natural gas is typically treated to remove or lower the amount of H₂S and CO₂ before it is used as a fuel or for other processing. As an example, for LNG applications, a portion of H₂S and CO₂ are removed to provide a stream having low levels of the contaminants (e.g., less than about 50 parts per million by volume (ppmv) CO₂ and less than about 4 ppmv H₂S). As another example, for pipeline applications, the H₂S should be removed to a very low level, e.g., less than about 4 ppmv, while the CO₂ may be removed to a lesser extent.

To remove the contaminants, cryogenic gas processes or solvent-based, higher temperature processes are conventionally used to remove CO₂ from the raw natural gas stream to prevent line freezing and orifice plugging. In addition, particularly with H₂S removal, the hydrocarbon-containing stream or natural gas stream may be treated with a solvent. Solvents may include chemical solvents, such as amines, and/or physical solvents. Examples of amines used in sour gas treatment include monoethanol amine (MEA), diethanol amine (DEA), and methyl diethanol amine (MDEA). The amine-based solvents rely on a chemical reaction with the acid gases, which is referred to as “gas sweetening.” Such chemical reactions are generally more effective than the physical-based solvents, particularly at feed gas pressures below about 300 pounds per square inch absolute (psia) (2.07 mega Pascal (MPa)).

As a result of the gas sweetening process, a treated or “sweetened” gas stream is further processed. The sweetened gas stream is substantially depleted of H₂S and CO₂. The sweetened gas stream can be further processed for liquids recovery by condensing out heavier hydrocarbon gases. The sweetened gas stream may be sold into a pipeline or may be used as a liquefied natural gas (LNG) feed if the concentrations of H₂S and CO₂ are low enough (e.g., the stream satisfies the respective specifications). In addition, the sweetened gas stream may be used as feedstock for a gas-to-liquids process, and then ultimately used to make waxes, butanes, lubricants, glycols, or other petroleum-based products.

Conventional equipment typically include large tower-based processes, which is used to remove some of the H₂S and CO₂ from the gaseous stream and tend to cover several square meters and weigh hundreds of tons. The weight and size are problematic for remote onshore processing applications, offshore processing applications, and subsea processing operations, where smaller equipment is preferred. Further, the transport and set-up of the conventional equipment is difficult for remote operations that frequently are performed in remote locations, such as certain shale gas production operations.

As an example, U.S. Patent Application Publication No. 2012/0240617 describes a process for sour gas treatment through the use of traditional absorption towers for acid gas removal. In particular, the reference describes removing acid gas from the stream with a first absorbent stream, regenerating the first rich absorbent solution stream, and compressing, then distilling the sour gas stream. This method involves an extended residence time and does not rely on enhanced H₂S-removal selectivity.

As another example, U.S. Patent Application Publication No. 2012/0240617 describes using pressure swing adsorption (PSA) technology to remove acid gas contaminant. In this method, a feed gas is separated to provide a H₂-enriched product stream and a stream of sour gas. Then, a portion of the sour gas stream has the H₂S removed. However, adsorption processes typically have reduced capacity for acid gas as compared to absorption. As such, the use of solid adsorbents in this system do not provide for the capacity, or reduced size of the treatment system. If the concentration of acid gas contaminants in the sour gas exceeds 0.5% to 1% or so, the mass of adsorbent material required becomes prohibitively large for even modest gas flow rates of a few hundred million standard cubic feet per day. While molecular sieves units may hold up to 20 weight percent (wt %) of water at start of run conditions, the high pressure gas may contain only a few tenths percent of water. For a similar weight capacity, the number of molecules of CO₂ that may be held compared to water molecules is in inverse proportion to their molecular weight (e.g., 18 divided by 44 or 41% of the molecules), while ten times the amount of molecules of contaminant may be in the feed stream. Thus, the amount of adsorbent material required may involve twenty-five times or more required than that involved with a corresponding dehydration application. This could amount to hundreds of thousands of pounds of adsorbent, which may be logistically infeasible.

Accordingly, there remains a need in the industry for apparatus, methods, and systems that provide enhancements for removal of contaminants, such as H₂S and CO₂, from a gaseous stream, such as a hydrocarbon-containing stream. The present techniques overcome the drawbacks of conventional absorption approaches by using smaller sized equipment to lessen the footprint and weight of the equipment in combination with reduced residence times. The present techniques provide a lower capital investment, lower operating expenses, smaller equipment footprint, and lower hydrocarbon losses, compared to conventional processes.

### SUMMARY

In one embodiment, a method for separating H₂S and CO₂ from a gaseous stream is described. The method includes: passing a gaseous stream to a compact contacting unit; mixing the gaseous stream with a selective solvent to form a mixed stream, wherein the selective solvent is configured to react with a first contaminant with a first reaction time and to react with a second contaminant with a second reaction time; performing an absorption step for a residence time period, wherein the first reaction time is less than the residence time period, and the second reaction time is greater than the residence time period; conducting away a contaminant stream having a portion of the first contaminant from the mixed stream, wherein the remaining mixed stream has a lower concentration of the first contaminant than the mixed stream; and removing the first contaminant from the process.

In other embodiments, the method may include various enhancements. For example, the method may include determining a concentration of CO₂ in the gaseous stream, comparing the concentration of CO₂ to a CO₂ threshold, and adjusting the flow rate of the selective solvent based on the comparison; may include determining a concentration of H₂S in the gaseous stream, comparing the concentration of H₂S to a H₂S threshold, and adjusting the flow rate of the selective solvent based on the comparison; may include measuring a temperature of the gaseous stream, and adjusting the flow rate of the selective solvent based on the measured temperature; may include measuring a pressure of the gaseous stream, and adjusting the flow rate of the selective solvent based on the measured pressure; may include wherein the selective solvent has kinetic differences in the absorption reactions for CO₂ and H₂S in a range between 10 and 1000 times, with the H₂S reaction being faster than the CO₂ reaction; may include wherein the residence time is managed to lessen any displacement of the H₂S molecules by CO₂ molecules; may include flashing the contaminant stream to remove one of a portion of the first contaminant, a portion of the second contaminant or any combination thereof; may include wherein the remaining portion or a liquid portion of the flashed contaminant stream is recycled to the mixing step as a portion of the selective solvent; and/or may include wherein the selective solvent is a tertiary amine, such as methyldiethanolamine, a formulated amine, a sterically-hindered amine.

In other embodiments, the method may include performing: mixing the remaining mixed stream with a second selective solvent to form a second mixed stream, wherein the second selective solvent is configured to react with the first contaminant with the first reaction time and to react with the second contaminant with the second reaction time; performing an absorption step for a second residence time period, wherein the first reaction time is less than the second residence time period, and the second reaction time is greater than the second residence time period; and conducting away a second contaminant stream having a portion of the first contaminant from the second mixed stream, wherein the remaining second mixed stream has a lower concentration of the first contaminant than the second mixed stream. These embodiments may also include flashing the second contaminant stream to remove one of a portion of the first contaminant, a portion of the second contaminant or any combination thereof and/or wherein the remaining portion or a liquid portion of the flashed second contaminant stream is recycled to the mixing step as a portion of the second selective solvent.

In another embodiment, a system for separating H₂S and CO₂ from a gaseous stream is described. The system includes a compact contacting unit configured to receive a gaseous stream. The compact contacting unit comprises a mixing stage, a mass transfer stage and a separation stage. The mixing stage is configured to mix the gaseous stream with a selective solvent to form a mixed stream, wherein the selective solvent is configured to react with a first contaminant with a first reaction time and to react with a second contaminant with a second reaction time. The mass transfer stage is downstream of the mixing stage and is configured to perform an absorption step for a residence time period, wherein the first reaction time is less than the residence time period, and the second reaction time is greater than the residence time period. The separation stage is downstream of the mass transfer stage and is configured to conduct away a contaminant stream having a portion of the first contaminant from the mixed stream, wherein the remaining mixed stream has a lower concentration of the first contaminant than the mixed stream.

In other embodiments, the system may include various enhancements. For example, the system may include a flash unit in fluid communication with the separation stage and configured to remove one of a portion of the first contaminant, a portion of the second contaminant or any combination thereof from the contaminant stream; may include a pump unit downstream of the flash unit and configured to pass the remaining portion or liquid portion of the flashed contaminant stream to the mixing stage as a portion of the selective solvent; may include a second compact contacting unit downstream of the compact contacting unit and configured to receive the remaining mixed stream, wherein the second compact contacting unit comprises a second mixing stage configured to mix the remaining mixed stream with a second selective solvent to form a second mixed stream, wherein the second selective solvent is configured to react with the first contaminant with the first reaction time and to react with the second contaminant with the second reaction time; a second mass transfer stage downstream of the second mixing stage and configured to perform an absorption step for a second residence time period, wherein the first reaction time is less than the second residence time period, and the second reaction time is greater than the second residence time period; and a second separation stage downstream of the second mass transfer stage and is configured to conduct away a second contaminant stream having a portion of the first contaminant from the second mixed stream, wherein the remaining second mixed stream has a lower concentration of the first contaminant than the second mixed stream. In addition, the system may include a second flash unit in fluid communication with the second separation stage and configured to remove one of a portion of the first contaminant, a portion of the second contaminant or any combination thereof from the second contaminant stream and/or a second pump unit downstream of the second flash unit and configured to pass the remaining portion or a liquid portion of the flashed second contaminant stream to the second mixing stage as a portion of the second selective solvent.

In other embodiments, the system may include a control system along with one or more sensors and regulators to manage the operation of the process. For example, the system may include a sensor configured to determine a concentration of contaminants in the gaseous stream; a flow regulator configured to adjust the flow rate of the selective solvent; and a control system configured to communicate with the sensor and the flow regulator and to compare the concentration of contaminants to a contaminant threshold; and to transmit an adjustment notification to the flow regulator to adjust the flow rate of the selective solvent based on the comparison, wherein the contaminants comprise one of CO₂, H₂S and any combination thereof. Further, the system may include a sensor configured to determine a measurement of a temperature or a pressure of the gaseous stream; a flow regulator configured to adjust the flow rate of the selective solvent; and a control system configured to communicate with the sensor and the flow regulator and to compare the measurement to a measurement threshold; and to transmit an adjustment notification to the flow regulator to adjust the flow rate of the selective solvent based on the comparison.

### BRIEF DESCRIPTION OF THE DRAWINGS

The foregoing and other advantages of the present disclosure may become apparent upon reviewing the following detailed description and drawings of non-limiting examples of embodiments.

FIG. 1 is a flow diagram of a process for removing contaminants from a gaseous stream in accordance with an embodiment of the present techniques.

FIG. 2 is a flow diagram of an alternative process for removing contaminants from a gaseous stream in accordance with an embodiment of the present techniques.

FIG. 3 is a diagram of a selective removal system in accordance with an embodiment of the present techniques.

FIG. 4 is a diagram of a portion of a selective removal system in accordance with an embodiment of the present techniques.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

Unless otherwise explained, all technical and scientific terms used herein have the same meaning as commonly understood by one of ordinary skill in the art to which this disclosure pertains. The singular terms “a,” “an,” and “the” include plural referents unless the context clearly indicates otherwise. Similarly, the word “or” is intended to include “and” unless the context clearly indicates otherwise. The term “includes” means “comprises.” All patents and publications mentioned herein are incorporated by reference in their entirety, unless otherwise indicated. In case of conflict as to the meaning of a term or phrase, the present specification, including explanations of terms, control. Directional terms, such as “upper,” “lower,” “top,” “bottom,” “front,” “back,” “vertical,” and “horizontal,” are used herein to express and clarify the relationship between various elements. It should be understood that such terms do not denote absolute orientation (e.g., a “vertical” component can become horizontal by rotating the device). The materials, methods, and examples recited herein are illustrative only and not intended to be limiting.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, “acid gas” refers to any gas that produces an acidic solution when dissolved in water. Non-limiting examples of acid gases include hydrogen sulfide (H₂S), carbon dioxide (CO₂), sulfur dioxide (SO₂), carbon disulfide (CS₂), carbonyl sulfide (COS), mercaptans, or mixtures thereof.

As used herein, “conduit” refers to a tubular member forming a channel through which something is conveyed. The conduit may include one or more of a pipe, a manifold, a tube or the like.

As used herein, “dehydrated gas stream” refers to a natural gas stream that has undergone a dehydration process. Typically the dehydrated gas stream has a water content of less than 50 ppm, and preferably less than 7 parts per million (ppm). Any suitable process for dehydrating the natural gas stream can be used. Typical examples of suitable dehydration processes include, but are not limited to, treatment of the natural gas stream with molecular sieves or dehydration using glycol or methanol. Alternatively, the natural gas stream can be dehydrated by formation of methane hydrates; for example, using a dehydration process as described in Intl. Patent Application Publication No. 2004/070297.

As used herein, “dehydration” refers to the pre-treatment of a raw feed gas stream to partially or completely remove water and, optionally, some heavy hydrocarbons. This can be accomplished by means of a pre-cooling cycle, against an external cooling loop or a cold internal process stream, for example. Water may also be removed by means of pre-treatment with molecular sieves, such as zeolites, or silica gel or alumina oxide or other drying agents. Water may also be removed by means of washing with glycol, monoethylene glycol (MEG), diethylene glycol (DEG), triethylene glycol (TEG), or glycerol. The amount of water in the gas feed stream is suitably less than 1 volume percent (vol %), preferably less than 0.1 vol %, more preferably less than 0.01 vol %.

As used herein, “distillation” or “fractionation” refers to the process of physically separating chemical components into a vapor phase and a liquid phase based on differences in the components' boiling points and vapor pressures at specified temperatures and pressures.

Distillation is typically performed in a “distillation column,” which includes a series of vertically spaced plates. A feed stream enters the distillation column at a mid-point, dividing the distillation column into two sections. The top section may be referred to as the rectification section, and the bottom section may be referred to as the stripping section. Condensation and vaporization occur on each plate, causing lower boiling point components to rise to the top of the distillation column and higher boiling point components to fall to the bottom. A reboiler is located at the base of the distillation column to add thermal energy. The “bottoms” product is removed from the base of the distillation column. A condenser is located at the top of the distillation column to condense the product emanating from the top of the distillation column, which is called the distillate. A reflux pump is used to maintain flow in the rectification section of the distillation column by pumping a portion of the distillate back into the distillation column.

As used herein, “enhanced oil recovery” (EOR) refers to processes for enhancing the recovery of hydrocarbons from subterranean reservoirs. Techniques for improving displacement efficiency or sweep efficiency may be used for the exploitation of an oil field by introducing displacing fluids or gas into injection wells to drive oil through the reservoir to producing wells.

As used herein, “fluid” may be used to refer to gases, liquids, combinations of gases and liquids, combinations of gases and solids, or combinations of liquids and solids.

As used herein, “gas” or “gaseous” is used interchangeably with “vapor,” and is defined as a substance or mixture of substances in the gaseous state as distinguished from the liquid or solid state. Likewise, the term “liquid”, as used herein, means a substance or mixture of substances in the liquid state as distinguished from the gas or solid state.

As used herein, “hydrocarbon” is an organic compound that primarily includes the elements hydrogen and carbon, although nitrogen, sulfur, oxygen, metals, or any number of other elements may be present in small amounts. As used herein, hydrocarbons generally refer to components found in natural gas, oil, or chemical processing facilities.

As used herein, “in direct flow communication” or “in direct fluid communication” means in direct flow communication without intervening valves or other closure means for obstructing flow. As may be appreciated, other variations may also be envisioned within the scope of the present techniques.

With respect to fluid processing equipment, the phrase “in series” means that two or more devices are placed along a flow line such that a fluid stream undergoing fluid separation moves from one unit of equipment to the next while maintaining flow in a substantially constant downstream direction. Similarly, the term “in line” means that two or more components of a fluid mixing and separating device are connected sequentially or, more preferably, are integrated into a single tubular device.

As used herein, “liquefied natural gas” (LNG) is natural gas generally known to include a high percentage of methane, such as greater than 90% by volume, for example. However, LNG may also include trace amounts of other elements or compounds. The other elements or compounds may include, but are not limited to, ethane, propane, butane, CO₂, nitrogen, helium, H₂S, or any combinations thereof, that have been processed to remove one or more components (for instance, helium) or impurities (for instance, water, acid gas, and/or heavy hydrocarbons) and then condensed into a liquid at almost atmospheric pressure by cooling.

As used herein, “liquid solvent” refers to a fluid in substantially liquid phase that preferentially absorbs one component over another. For example, a liquid solvent may preferentially absorb an acid gas, thereby removing or “scrubbing” at least a portion of the acid gas component from a gas stream or a water stream.

As used herein, “natural gas” refers to a multi-component gas obtained from a crude oil well or from a subterranean gas-bearing formation. The composition and pressure of natural gas can vary significantly. A typical natural gas stream contains methane (CH₄) as a major component, i.e., greater than 50 mole percentage (mol %) of the natural gas stream is methane. The natural gas stream can also contain ethane (C₂H₆), higher molecular weight hydrocarbons (e.g., C₃ to C₂₀ hydrocarbons), one or more acid gases (e.g., CO₂ or H₂S), or any combinations thereof. The natural gas can also contain minor amounts of contaminants, such as water, nitrogen, iron sulfide, wax, crude oil, or any combinations thereof. The natural gas stream may be substantially purified according to embodiments described herein, so as to remove compounds that may act as poisons.

As used herein, “non-absorbing gas” refers to a gas that is not significantly absorbed by a solvent during a gas treating or conditioning process.

As used herein, “compact contacting technology” is a technology that includes various stages to remove contaminants from a gaseous stream. The compact contacting technology includes a mixing stage that involves mixing a solvent stream with a feed stream, a mass transfer stage that involves a residence time for absorption reactions, and a separation stage that involves separating the hydrocarbons from the solvent. Exemplary compact contacting technologies are described in U.S. Patent Application Publication Nos. 2011/0168019; 2012/0238793; 2014/0123620; 2014/0331862; 2014/0335002; and 2015/0352463 and U.S. Ser. Nos. 14/948,422; 15/004,348 and 15/009,936, which are each herein incorporated by reference in their entirety.

As used herein, “solvent” refers to a substance capable at least in part of dissolving or dispersing one or more substances, such as to provide or form a solution. The solvent may be polar, nonpolar, neutral, protic, aprotic, or the like. The solvent may include any suitable element, molecule, or compound, such as methanol, ethanol, propanol, glycols, ethers, ketones, other alcohols, amines, salt solutions, ionic liquids, or the like. The solvent may include physical solvents, chemical solvents, or the like. The solvent may operate by any suitable mechanism, such as physical absorption, chemical absorption, or the like.

As used herein, “stream” refers to fluid (e.g., solids, liquid and/or gas) being conducted through various equipment. The equipment may include conduits, vessels, manifolds, units or other suitable devices.

As used herein, “substantial” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

As used herein, “sweetened gas stream” refers to a fluid stream in a substantially gaseous phase that has had at least a portion of acid gas components removed.

The present techniques provide for the separation of contaminants, such as CO₂ and H₂S, from a gaseous stream, such as a natural gas stream. More specifically, in various embodiments, the present techniques may be used to reduce the size, footprint and associated weight of a variety of facilities for selective contaminant removal as compared to conventional equipment. The present techniques may be useful for onshore applications, remote onshore applications, topsides facilities on offshore and floating applications, and subsea processing facilities with regard to separation and absorption of contaminants. The present techniques integrate of compact contacting technology with solvents having specific selectivity.

In one or more embodiments, the present techniques can be used for any type of separation and absorption process for removal of contaminants. These processes may include compact contacting technology in the areas of dehydration, selective H₂S removal, and CO₂ removal. The compact contacting technology may include various stages, which may include a mixing stage involving mixing a solvent stream with a feed stream, a mass transfer stage involving a residence time for absorption reactions, and a separation stage involving separating the hydrocarbons from the contaminants. The stages may be performed in a serial sequence, such as a first mixing stage, a first mass transfer stage and then a first separation stage, which is followed by a second mixing stage, a second mass transfer stage and then a second separation stage, which may involve any number of similar sequences of stages in the compact contacting technology. By way of example, the compact contacting technology may involve individual contacting sections or stages where absorption may be affected through co-current contacting. Each stage involves gas and liquid entering an in-line mixer, which has the mixed stream conducted away from the mixer and continues into a mass transfer section where absorption occurs. A separation section follows the mass transfer section where entrained liquid droplets are removed from the gas stream, resulting in a gas phase stream conducted away from the separation section. The process may be configured to include one or more absorption stages each containing a mixer, mass transfer section, and separation section, which may be based on different contaminants. In particular, the process can be operated with a lean solvent entering each individual stage or the process can be configured with an overall countercurrent flow of the solvent with co-current contacting in individual stages. In the configuration, regenerated or fresh solvent is injected into the final stage and liquid conducted away from a stage containing the contaminant is fed as the inlet to the previous stage. The flow path is continued through each stage until the liquid removed from the first stage is the liquid stream containing the highest levels of absorbed contaminant. In addition, the use of a series of co-current contacting systems for natural gas processing and solvent regeneration may provide a reduction in the size of the overall system as compared to conventional approaches. As a result, the enhancements may reduce the operating costs for the system.

As may be appreciated, the compact contacting technology can be oriented both horizontally or vertical orientation. Accordingly, in other embodiments, the present techniques can be arranged in various configurations including both horizontal and vertical sections, stages with or without in-line separation immediately following contacting, and with dehydration, H₂S removal, and CO₂ removal occurring in subsequent portions of a single in-line device. To scale-up the volume being processed, the present techniques may involve bundling the units into a single pressure vessel oriented vertically and/or horizontally. The present techniques may utilize physical solvents and/or liquid-liquid extraction. Preventing the accumulation of liquid on the inner surface of the mass transfer section can enhance absorption performance, while coalescing droplets and the inlet of the in-line separation device can enhance separation performance.

The processes, apparatus, and systems of the present techniques may be used to remove contaminants (e.g., CO₂ and H₂S) from feed streams, such as hydrocarbon-containing streams or hydrocarbon feed streams. As may be appreciated, the hydrocarbon feed streams may have different compositions. For example, hydrocarbon feed streams vary widely in amount of acid gas, such as from several parts per million acid gas to 90 volume percent (vol. %) acid gas. Non-limiting examples of acid gas concentrations from exemplary gas reserves sources include concentrations of approximately: (a) 4 parts per million volume (ppmv) H₂S, 2 vol. % CO₂, 100 ppmv H₂O (b) 4 ppmv H₂S, 0.5 vol. % CO₂, 200 ppmv H₂O (c) 1 vol. % H₂S, 2 vol. % CO₂, 150 ppmv H₂O, (d) 4 ppmv H₂S, 2 vol. % CO₂, 500 ppmv H₂O, and (e) 1 vol. % H₂S, 5 vol. % CO₂, 500 ppmv H₂O. Further, in certain applications, the hydrocarbon-containing stream may include predominately hydrocarbons with specific amounts of H₂S, CO₂ and/or water. For example, the hydrocarbon-containing stream may have greater than 0.00005 volume percent CO₂ based on the total volume of the gaseous feed stream and less than 2 volume percent CO₂ based on the total volume of the gaseous feed stream; or less than 10 volume percent CO₂ based on the total volume of the gaseous feed stream.

The processing of feed streams may be more problematic when certain specifications have to be satisfied. Accordingly, the present techniques provide configurations and processes that are utilized to enhance the separation of contaminants from a feed stream to form a natural gas stream or a liquefied natural gas (LNG) stream that complies with respective specifications, such as a pipeline specification or an LNG specification. For example, natural gas feed streams for liquefied natural gas (LNG) applications have stringent specifications on the CO₂ content to ensure against formation of solid CO₂ at cryogenic temperatures. The LNG specifications may involve the CO₂ content to be less than or equal to 50 ppmv. Such specifications are not applied on natural gas streams in pipeline networks, which may involve the CO₂ content up to 2 vol. % based on the total volume of the gaseous feed stream. As such, for LNG facilities that use the pipeline gas (e.g., natural gas) as the raw feed, additional treating or processing steps are utilized to further purify the stream. Further, the pipeline specification or LNG specification for H₂S may require the stream to maintain concentrations of less than 4 ppm H₂S.

Moreover, the present techniques may be used to lessen the water content of the stream to a specific level. For example, the water content of a feed stream may range from a few ppmv to saturation levels in the stream. In particular, the water content may range from a few hundred ppmv to saturation levels, such as 500 ppmv to 1500 ppmv dependent on the feed pressure. The specific water level of the product stream from the absorption process may be related to dew point of desired output product (e.g., the dew point from the water content should be lower than the lowest temperature of the stream in a subsequent process, such as liquefaction and is related to the feed pressure and feed composition). For LNG applications, the water content may be less than 0.1 ppm, as the dew point may be −150° F. For cryogenic Natural Gas Liquid (NGL) recovery applications, the water content may be less than 1 ppm, as the dew point may be about −260° F. For control freeze zone (CFZ) applications, the water content may be less than 10 ppm, as the dew point may be about −60° F.

As noted above, acid gas removal from natural gas is an expensive and equipment intensive process. In particular, the removal of hydrogen sulfide (H₂S) from natural gas streams is especially complicated due to the corrosive and toxic nature of H₂S and the resulting sulfur by-products being processed into solid sulfur or injection of H₂S through acid gas injection methods. Accordingly, acid gas is treated and managed in a variety of approaches in the natural gas industry, depending on the concentrations, pressures, and final disposition of the gas and contaminants. Most natural gas pipelines have a specification that requires sales gas to maintain concentrations of less than 4 ppm H₂S and 2 vol. % CO₂ for transportation in the pipeline, as noted above. This specification is utilized to maintain the integrity of the pipeline by reducing corrosion of the stream being transported in the pipeline. As a result, a feed stream may have an acid gas concentration that may require simultaneous removal of CO₂ and H₂S, only removal of CO₂, or only removal of H₂S to comply with the pipeline specifications. Other configurations may also remove H₂O.

By way of example, in CO₂ removal, the H₂S concentration may already be less than 4 ppm and CO₂ is the contaminant that needs to be removed. In this process, an amine solvent, such as activated methyldiethanolamine (aMDEA®), (MHI), or molecular sieves for low concentrations of CO₂ may be used to remove the CO₂. If both CO₂ and H₂S need to be removed simultaneously, the process may likewise involve the use of an activated solvent as described above.

Further, for selective H₂S removal, the present techniques may be used to enhance the removal of H₂S to satisfy the respective specification, while leaving as much CO₂ as possible in the gaseous stream. This approach may be used when the concentration of CO₂ satisfies the specification or when you need to remove H₂S to prevent corrosion issues for pipeline transportation, but can tolerate higher CO₂ concentrations. The selective H₂S removal may be achieved amine solvents, such as aMDEA or formulated amine-based solvents, such as ExxonMobil's FLEXSORB® SE and FLEXSORB® SE Plus.

These H₂S-selective solvents may take advantage of the kinetic differences in the absorption reactions for CO₂ and H₂S with certain classes of amines. The amines in this class of solvents (sterically-hindered amines), react quickly with H₂S, while reactions to absorb CO₂ are slow due to steric hindrance blocking CO₂ access to the amino-hydrogen. Selective H₂S solvents can be a blend of multiple amines that have a variety of kinetic interactions with acid gas. Because the selectivity of solvents is based on differing reaction rates between the solvent and different contaminants in the gas, the residence time in absorption towers is a factor or design parameter that is utilized to manage H₂S reaction (e.g., maximize H₂S absorption), while lessening CO₂ absorption (e.g., minimizing the residence time to lessen the CO₂ reactions). The selectivity of the solvent is based on the amount of H₂S that is absorbed relative to the amount of CO₂. For example, the selectivity may be represented by the following equation (e1):

S=([H₂S]_{AG}/[CO₂]_{AG})/([H₂S]_{Feed}/[CO₂]_{Feed}) (e1)

where a compound in brackets “[ ]” denotes molar concentration of the compound, the subscript “AG” denotes acid gas, and the subscript “Feed” denotes feed gas. Solvents with high selectivity to H₂S favor absorption of H₂S and are preferred for selective H₂S removal applications because the required equipment size may be reduced and the flow rate of solvents utilized may result in smaller equipment and smaller solvent flowrates, as compared with the less selective or conventional equipment or solvents. At high partial pressures of acid gas, typically at least 50 psi in the feed, physical solvents, such as Selexol by UOP L.L.C., may be used to remove CO₂ and H₂S simultaneously, or it can perform selective H₂S removal.

The present techniques may further enhance acid gas treating, and specifically, selective H₂S removal, which is becoming useful in processing facilities for natural gas assets to reduce process complexity, capital expenditures, operating expenses, weight, space, and footprint. The enhancements may lessen the footprint, lessen the equipment weight, lessen operability complexity, or enhance reliability in these processes, which are beneficial in the natural gas treating industry. The present techniques provide enhancements that are focused on the integrated combination of an H₂S-selective solvent with specific characteristics of the compact contacting technology. The functionality and benefits, such as lessened equipment footprint, lessened weight of the equipment, lessened equipment size, etc., are provided through the combination of the selective solvent and the compact contacting technology. While the selective H₂S solvent and equipment of compact contacting technology operate independently, the combined selective removal system provides unique functionality that is an enhancement over the individual aspects. By using the combined selective removal system, the small size and high velocity of fluids flowing through the system results in a lessened residence time for contacting and/or absorption of the specific contaminants. As described above, selective solvents, such as a H₂S-selective solvent, may be used when the concentration of contaminants, such as H₂S, in a stream should be lessened, but the concentration of CO₂ in the stream does not have to be lessened. Because the amine functionality of solvents may also absorb CO₂, the selectivity is based on the reaction rates of H₂S and CO₂ with the amine group(s) on the solvent of interest.

By way of example, the initial reactions of acid gases with primary amines (R—NH₂) are shown in equations (e2), (e3) and (e4). The subsequent reactions and speciation are not shown, but should be apparent to one skilled in the art. The initial reactions of acid gases with primary amines (R—NH₂) are shown as follows:

R—NH₂+H₂S→R—NH₂H⁺+SH— (e2)

R—NH₂+CO₂+H₂O→R—NH₂H⁺+HCO₃— (e3)

2R—NH₂+CO₂+H₂O→R—NH₂H⁺+R—NHCO₂— (e4)

The first reaction in equation (e2) is a fast reaction and has a reaction rate constant k₁. In this equation (e2), the H₂S rapidly deprotonates and the proton readily reacts with the amine function of the solvent. The second reaction in equation (e3) comprises a series of relatively slow reactions and has an overall reaction rate constant k₂. The third reaction (e4) is referred to as the carbamate reaction, which is relatively fast. Tertiary amines, such as MDEA, do not have hydrogen atoms attached to the amino nitrogen atom, and therefore cannot participate in the carbamate reaction. Thus, CO₂ can react with those amines only via (e3), which takes place in tenths of seconds instead of milliseconds in the case of H₂S reaction (e2). Highly selective solvents have kinetic rates where k₁ is substantially greater than (>>) k₂ to promote H₂S absorption and hinder or slow CO₂ absorption.

Another characteristic of these reactions in equations (e2), (e3) and (e4) is the equilibrium reaction constant. Each amine has a specific CO₂ equilibrium reaction constant for the reaction of that amine with CO₂, and a specific H₂S equilibrium reaction constant for the reaction of that amine with H₂S. The equilibrium reaction constant represents what the concentration of absorbed acid gas may be if the reactions are left to reach equilibrium, e.g., after a long period of time. The values of the respective equilibrium constants depend on the solvent, reaction temperature, reaction pressure and the specific structure of the amine. At equilibrium, amines may absorb more CO₂ than H₂S because CO₂ is a stronger acid than H₂S. Accordingly, the present techniques may utilize the difference in reaction rates for selective H₂S removal. Although the reactions with H₂S molecules may be faster than the reactions with the CO₂ molecules, the residence time is managed to lessen any displacement of the H₂S molecules by CO₂ molecules. For example, natural gas treating involving selective H₂S removal has to manage residence time to maximize H₂S absorption and minimize CO₂ absorption. In selective H₂S solvents, the CO₂ reaction, while slower than the reactions of H₂S, still occurs in solution. While a certain amount of CO₂ absorption is unavoidable, more CO₂ molecules may be absorbed if there is excessive contact time with the feed gas.

The management of residence time in a selective H₂S system may enhance operation of the method. The combination of a selective H₂S solvent and compact contactor equipment provide the benefit of reduced CO₂ pickup through reduced contact time. As a result, the lessened residence time enhances the H₂S-selectivity by limiting the CO₂ reaction, which takes longer to occur.

By way of example, parameters associated with the present techniques may be quantified by examining triethyleneglycol (TEG) contacting for dehydration of natural gas in a co-current device. In this example, the residence time for dehydration in a single stage of contacting was measured, as shown in Table 1. The test covered a range of conditions, such as 500 pounds per square inch absolute (psia) and 1000 psia, 90° F. (Fahrenheit), 2.0 to 11.4 thousand standard cubic feet per day (Mscfd), 1.5 to 11.3 gallons glycol circulated per pound of H₂O absorbed, and 98.7 weight percentage (wt %) and 99.9 wt % triethyleneglycol (TEG) in solution. The tests were performed with a single stage of contacting, and through modeling it was determined that dehydration to pipeline specification can be achieved in two dehydration stages. For example, based on the data from the single-stage testing, the second stage of dehydration may be mathematically modeled using a similar mass transfer device and similar amount of lean TEG. The values for this examples are compared with that of a typical glycol contactor dehydrating treating large volumes of natural gas.

TABLE 1

| Equipment | Gas Velocity | | Residence Time |
|---|---|---|---|
| Compact Contacting | 2.8 to 7.4 m/s | 9 to 24 ft/s | 0.03 to 0.1 s |
| Technology | | | |
| Compact Contacting | 2.8 to 7.4 m/s | 9 to 24 ft/s | 0.06 to 0.2 s |
| Technology two stage | | | |
| estimate based on model | | | |
| Conventional Glycol | 0.5 to 0.6 m/s | 1 to 2 ft/s | 8 to 15 s |
| Contacting Tower | | | |

In Table 1, the compact contacting technology and compact contacting technology-two stage estimate examples have gas velocities of 2.8 meters/second (m/s) to 7.4 m/s (9 to 24 feet/second (ft/s)), but the residence time is twice as long for the compact contacting technology-two stage estimate example. In the two-stage equipment example, the second stage was simulated using partially dehydrated gas from the first stage, and contacting it with fresh TEG in a manner very similar to that of the first stage. As a result, the gas exiting the second stage may be established as meeting a typical pipeline specification of 4 pound (lb) H₂O/million cubic feet (MMCF) to 7 lb H₂O/MMCF (e.g., 84 ppm H₂O to 147 ppm H₂O). The conventional glycol contacting tower example has lower gas velocities and results in residence time that is much larger than the compact contacting technology and compact contacting technology-two stage estimate examples. The compact contacting technology and compact contacting technology-two stage estimate examples show residence times that are two orders of magnitude lower than that of the glycol contacting towers. However, the excess residence time in the TEG configurations is not deleterious as there is not another contaminant that displaces H₂O from the TEG over time.

As the glycol contacting for dehydration of natural gas should be similar to the selective H₂S removal, the present techniques provide the following benefits. First, the highly selective solvents provide even higher selectivity in the compact contacting technology system, resulting in both smaller equipment and enhanced selectivity (e.g., lessened solvent circulation, smaller regeneration equipment, and lessened solvent inventory requirements, etc.). This is because the CO₂ (though possibly higher in concentration than the H₂S) does not have time to react and displace H₂S from the solution. This means that less solvent is needed to absorb the amount of H₂S needed to meet the produce specification. As a result, the ancillary equipment (e.g., solvent regenerator) may be smaller, and less costly compared to other systems that involve more solvent. In addition, the concentrated acid gas from the regenerator is more concentrated in H₂S, which reduces the size of the sulfur recovery unit (SRU). In the preferred configurations, the need for an acid gas enrichment (AGE) unit may also be eliminated, substantially reducing equipment count. Second, solvents that may absorb CO₂ for a given application may be used with selective H₂S removal equipment or compact contacting equipment to meet treating specification. This may result in smaller equipment and being able to use a less expensive solvent.

The present techniques do not specify that a particular solvent has to be used, but any solvent that is used to remove H₂S and CO₂ can be made selective, or more selective by employing the technique of limiting the contact time with CO₂. Solvents (or their mixtures) may include, but are not limited to, primary amines (monoethanolamine (MEA), 2(2-aminoethoxy) ethanol (aka Diglycolamine® (DGA), etc.), secondary amines (diethanolamine (DEA), diisopropanolamine (DIPA), etc.), tertiary amines (methyldiethanolamine (MDEA), triethyleneamine (TEA)), hindered amines (FLEXSORB® SE, 2-amino-2-methyl-1-propanol (AMP), etc.), or formulated amines (FLEXSORB® SE PLUS, UCARSOL family of products, formulated MDEA solutions, etc.). The enhancements from the present techniques may utilize the combination of FLEXSORB® SE and FLEXSORB® SE PLUS with the compact contacting technology.

As a further enhancement, the configuration may include a combination of compact contacting technology and tertiary amines (e.g., MDEA). This specific combination enhances selectivity when a rich amine is flashed between counter-currently arranged stages. In this configuration, the interstage flashing partially unloads the amine, so it is able to pick up more acid gas in each succeeding stage. Perhaps the slower reaction of CO₂ (hydration, followed by carbonic formation) is more easily reversed under pressure reduction.

In one embodiment, a method for separating H₂S and CO₂ from a gaseous stream is described. The method includes: passing a gaseous stream to a compact contacting unit; mixing the gaseous stream with a selective solvent to form a mixed stream, wherein the selective solvent is configured to react with a first contaminant with a first reaction time and to react with a second contaminant with a second reaction time; performing an absorption step for a residence time period, wherein the first reaction time is less than the residence time period, and the second reaction time is greater than the residence time period; conducting away a contaminant stream having a portion of the first contaminant from the mixed stream, wherein the remaining mixed stream has a lower concentration of the first contaminant than the mixed stream; and removing the first contaminant from the process.

In other embodiments, the method may include various enhancements. For example, the method may include determining a concentration of CO₂ in the gaseous stream, comparing the concentration of CO₂ to a CO₂ threshold, and adjusting the flow rate of the selective solvent based on the comparison; may include determining a concentration of H₂S in the gaseous stream, comparing the concentration of H₂S to a H₂S threshold, and adjusting the flow rate of the selective solvent based on the comparison; may include measuring a temperature of the gaseous stream, and adjusting the flow rate of the selective solvent based on the measured temperature; may include measuring a pressure of the gaseous stream, and adjusting the flow rate of the selective solvent based on the measured pressure; may include wherein the selective solvent has kinetic differences in the absorption reactions for CO₂ and H₂S in a range between 10 and 1000 times, with the H₂S reaction being faster than the CO₂ reaction; may include wherein the residence time is managed to lessen any displacement of the H₂S molecules by CO₂ molecules; may include flashing the contaminant stream to remove one of a portion of the first contaminant, a portion of the second contaminant or any combination thereof; may include wherein the remaining portion or liquid portion of the flashed contaminant stream is recycled to the mixing step as a portion of the selective solvent; and/or may include wherein the selective solvent is a tertiary amine, such as methyldiethanolamine, a formulated amine, a sterically-hindered amine.

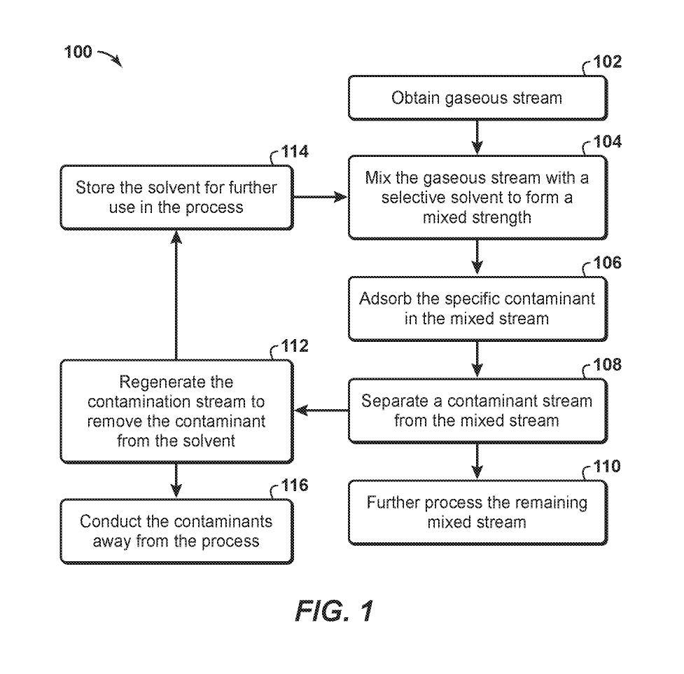

In other embodiments, the method may include performing: mixing the remaining mixed stream with a second selective solvent to form a second mixed stream, wherein the second selective solvent is configured to react with the first contaminant with the first reaction time and to react with the second contaminant with the second reaction time; performing an absorption step for a second residence time period, wherein the first reaction time is less than the second residence time period, and the second reaction time is greater than the second residence time period; and conducting away a second contaminant stream having a portion of the first contaminant from the second mixed stream, wherein the remaining second mixed stream has a lower concentration of the first contaminant than the second mixed stream. These embodiments may also include flashing the second contaminant stream to remove one of a portion of the first contaminant, a portion of the second contaminant or any combination thereof and/or wherein the remaining portion or a liquid portion of the flashed second contaminant stream is recycled to the mixing step as a portion of the second selective solvent. The present techniques may be further understood with reference to the FIGS. 1 to 4 below.

FIG. 1 is a flow diagram 100 of an exemplary method to remove contaminants for a gaseous streams in accordance with an exemplary embodiment of the present techniques. In this diagram 100, the method may be used to adjust (e.g., lower or lessen) the contaminants in a gaseous stream using selective solvent and a Compact Contacting Technology equipment. In particular, the gaseous stream, which may be a hydrocarbon-containing stream (e.g., a natural gas stream or a hydrotreater outlet stream), may be passed through a mixing stage, a mass transfer stage and a separation stage to lower a specific contaminant, such as H₂S. The selective solvent may be selected based on the residence time and associated reaction time for the solvent to the specific contaminant.

The method begins at block 102. In block 102, a gaseous stream is obtained. The gaseous stream may be a hydrocarbon-containing stream, such as a natural gas stream, an LNG feed stream or other such stream. At block 104, the gaseous stream is mixed with a selective solvent to form a mixed stream. The selective solvent may be selected to be a tertiary amine. By way of example, an LNG feed gas may use an activated amine to pick up CO₂ as well, which may not be an H₂S-selective amine. The gaseous stream may be mixed with the solvent in a mixer. At block 106, the specific contaminant is adsorbed by the solvent in the mixed stream. The adsorbing of the contaminant may be performed for a specific residence time that promotes interaction of the solvent and the specific contaminant, such as H₂S, but is lower than the reaction time for other contaminants, such as CO₂. At block 108, a contaminant stream is separated from the mixed stream. The separation may involve a physical separation, where entrained liquid droplets are conducted away from the mixed stream, resulting in the remaining mixed stream being a gas phase stream conducted away from the separation section, while the contaminant stream is a liquid and/or mixed gas and liquid phase stream conducted away from the separation section. The remaining mixed stream, which may be referred to as a hydrocarbon-enriched stream, is further processed, as shown in block 110. The further processing of the hydrocarbon-enriched stream may include selling the hydrocarbons, passing the hydrocarbons to a pipeline or further processing the hydrocarbon-enriched stream downstream of this process.

Then, the contaminant stream may be further processed in a regeneration stage to reclaim the solvent. At block 112, the contamination stream is regenerated to remove contaminants from the desorbed solvent stream. The regeneration may include desorbing the contaminants from the contamination stream to a contaminant gas phase stream and a desorbed solvent stream. The desorbed solvent stream may be stored and/or used for further use in the process, as shown in block 114. For example, the desorbed solvent may be passed to a storage tank for use as the solvent in block 104. The desorbed solvent stream may be stored and/or used for further use, as shown in block 116. The contaminants may include H₂S and/or CO₂.

Beneficially, the process utilizes the unexpected synergy between the selective amine and short contact time process. The shorter contact time relative to a normal gas-liquid contactor prevents excess CO₂ from being absorbed in the solution and displacing H₂S from it. Thus, the outlet selectivity is higher than that for an H₂S-selective amine in a conventional contactor. In some configurations, the enhanced selectivity may eliminate the use of or need for an AGE unit. This configuration may be utilized in various onshore applications, remote onshore applications, topsides facilities on offshore and floating applications, and subsea processing facilities with regard to separation and absorption of contaminants. By way of example, the process may be used for an existing production facility that has experienced an increase in a specific contaminant, such as H₂S. This process may be utilized upstream of the existing equipment and provide additional H₂S removal to maintain the production operations.

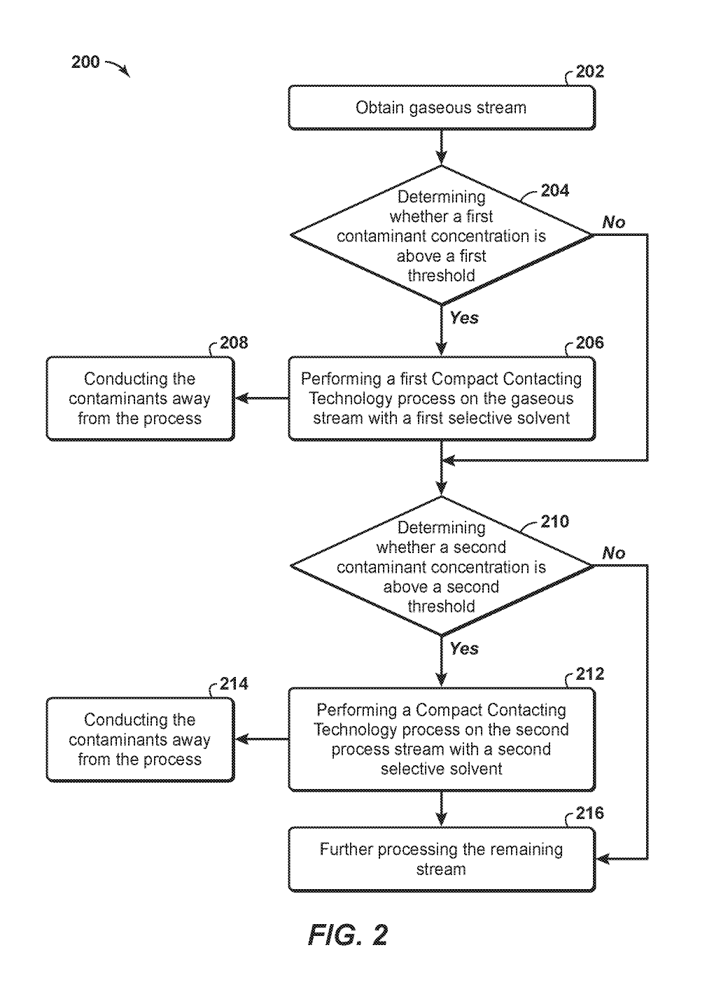

FIG. 2 is a flow diagram 200 of an exemplary method to remove two or more contaminants for a gaseous streams in accordance with an exemplary embodiment of the present techniques. In this diagram 200, the method may be used to adjust (e.g., lower or lessen) the contaminants in a gaseous stream using two different selective solvents and a compact contacting technology equipment. In particular, the gaseous stream, which may be similar to the stream in FIG. 1, may be passed through a first specific contaminant removal process utilizes the compact contacting technology equipment (e.g., mixing stage, a mass transfer stage, a separation stage and regeneration stage) to lower a specific first contaminant. Then, the remaining stream may be passed through a second specific contaminant removal process utilizing the compact contacting technology equipment to lower a specific second contaminant. The selective solvent for each of the processes may be selected based on the residence time and associated reaction time for the solvent to the specific contaminant being targeted for removal in that portion of the process.

The method begins at block 202. In block 202, a gaseous stream is obtained. The gaseous stream may be a hydrocarbon-containing stream, such as a natural gas stream, an LNG stream or other such stream. The blocks 204 to 208 may be used to target and remove a first contaminant from the gaseous stream. At block 204, a determination is made whether a first contaminant concentration is above a first threshold. This determination may involve comparing the first contaminant concentration to a specification concentration level or other suitable predetermined concentration level, which is associated with the first contaminant. If the first contaminant concentration is below or equal to the first threshold, then the gaseous stream may bypass the first compact contacting technology process and proceed to block 210. However, if the first contaminant concentration is above the first threshold, then passing the gaseous stream to the first compact contacting technology process. As shown in block 206, the first compact contacting technology process is performed on the gaseous stream with the first selective solvent. The performing the first compact contacting technology process may include performing the mixing stage, mass transfer stage, separation stage and regeneration stage for the gaseous stream with the first selective solvent. By way of example, the first compact contacting technology process may perform the process described in blocks 104, 106, 108, 112 and 114 of FIG. 1 with the selective solvent being the first selective solvent. In block 208, the contaminants from the first compact contacting technology process may be conducted away from the process. As an example, the contaminant being targeted in the first compact contacting technology process may be H₂S. The remaining mixed stream is passed to block 210.

The blocks 210 to 214 may be used to target and remove a second contaminant from the gaseous stream in block 204 or the remaining mixed stream from block 206, which may be referred to as the second process stream. At block 210, a determination is made whether a second contaminant concentration is above a second threshold. This determination may involve comparing the second contaminant concentration to a specification concentration level or other suitable predetermined concentration level, which is associated the second contaminant. If the second contaminant concentration is below or equal to the second threshold, then the second process stream may bypass the second compact contacting technology process and may proceed to block 216. However, if the second contaminant concentration is above the second threshold, then the second process stream is passed to the second compact contacting technology process. As shown in block 212, the second compact contacting technology process is performed on the second process stream with the second selective solvent. The performing the second compact contacting technology process may include performing the mixing stage, mass transfer stage, separation stage and regeneration stage for the second process stream with the second selective solvent. By way of example, the second compact contacting technology process may perform the process described in blocks 104, 106, 108, 112 and 114 of FIG. 1 with the selective solvent being the second selective solvent. In block 214, the contaminants from the second compact contacting technology process may be conducted away from the process. As an example, the contaminant being targeted in the second compact contacting technology process may be CO₂. The remaining stream from block 212, which may be referred to as a hydrocarbon-enriched stream, is further processed, as shown in block 216. The further processing of the hydrocarbon-enriched stream may include selling the hydrocarbons, passing the hydrocarbons to a pipeline or further processing the hydrocarbon-enriched stream downstream of this process.

Beneficially, this configuration provides much smaller weight and foot print of the gas-liquid contacting device. Furthermore, the ancillary equipment including pumps, pipes, filters, carbon filters, coolers, cross-exchangers, reboilers and regenerator are all smaller and lighter due to reduced solvent circulation rate. An example would be for a floating LNG (FLNG) facility where deck space is very expensive. Instead of a large diameter, thick-walled vessel to remove a small quantity of H₂S and CO₂ to meet an LNG feed specification, a series of two or three co-current contactors may be placed in a countercurrent configuration to substantially reduce weight and footprint. In another example configuration, the enhanced selectivity of the solvent-contactor combination may be such that the solvent circulation rate is greatly reduced, making all associated equipment smaller for a pipeline gas configuration where up to 3 mole percent (%) inerts can be provided to the sales pipeline. The corresponding regeneration energy may also be smaller.

As may be appreciated, the methods in FIGS. 1 and 2 may include additional control equipment that is utilized to manage reactions of the selective solvent with the gaseous stream. The control equipment may be utilized to manage the flow rate of the selective solvents, which may be based on measurements of the contaminant concentrations, the temperature of the gaseous stream, and the pressure of the gaseous stream. These measurements may be obtained by sensors to manage the removal of contaminants through the absorption reactions because the circulation rate of solvent, the solvent loading, outlet temperature, contactor pressure and the specific structure of the amine may influence the equilibrium reaction constant as well as the kinetics of the competing H₂S and CO₂ absorption reactions. Accordingly, the measurements may be used to adjust the flow rate of the selective solvents and the absorption reaction rates within the mixed stream.

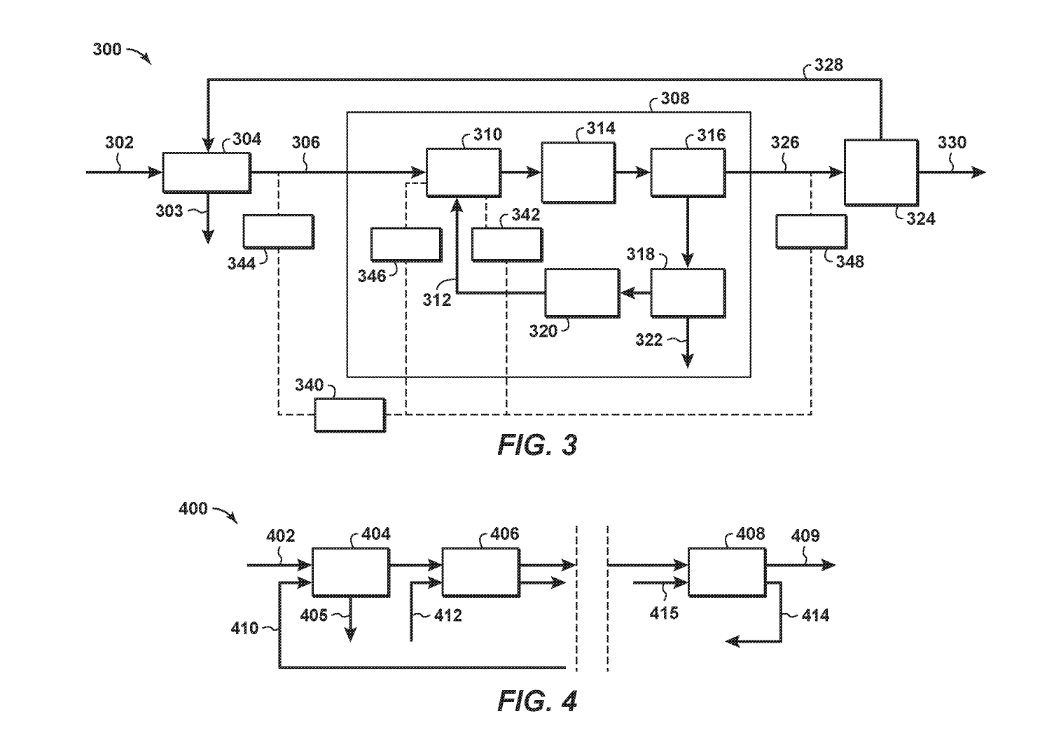

FIG. 3 is a diagram of a selective removal system 300 in accordance with an embodiment of the present techniques. This selective removal system may utilize the compact contacting technology process in combination with the selective solvent to enhance the contaminant removal from a gaseous stream.

In this system 300, the gaseous stream, which may be a sour natural gas stream, is provided via conduit 302 and may be flowed to an inlet separator 304. The inlet separator 304 may be used to clean the gaseous stream by filtering out impurities, such as brine, drilling fluids and/or particles. This cleaning of the gaseous stream may lessen foaming of solvent during the acid gas treatment stages. The impurities may be conducted away from the gaseous stream via conduit 303.

From the inlet separator 304, the gaseous stream may be passed via conduit 306 to the compact contacting technology system 308. The compact contacting technology system 308 may include a mixer 310, a mass transfer unit 314, a separator 316, a regeneration section 318 and a storage unit 320. In the system 308, the gaseous stream is provided to the mixer 310 along with a selective solvent provided from the storage unit 320 via conduit 312. The mixer 310 is utilized to force interaction between the respective streams and pass the resulting mixed stream to the mass transfer unit 314. The solvent stream may include an amine solution, such as monoethanol amine (MEA), diethanol amine (DEA), or an H₂S-selective amine like methyldiethanolamine (MDEA) or Flexsorb SE®. Other solvents, such as physical solvents, alkaline salts solutions, or ionic liquids, may also be used for H₂S removal.

As the mixed stream passes through the mass transfer unit 314, the mixed stream interacts with the contaminant, such as the CO₂ and/or H₂S, in the mixed stream causing the contaminants to chemically attach to or be absorbed by the amine molecules. The mixed stream is maintained in the mass transfer unit 314 for a specific residence time and then may be passed to the separator 316. The separator 316 may perform a phase separation and pass the contaminated solvent stream to the regeneration unit 318 and the remaining mixed stream (e.g., the hydrocarbon-enriched stream) to the hydrocarbon storage unit 324 via conduit 326. The hydrocarbon-enriched stream may be passed via conduit 330 for sales, to a pipeline, or further processing. The separator 316 may be a knockout drum or other suitable separation unit that divides the adsorbed contaminants from the other hydrocarbons. The regeneration unit 318 may desorb the contaminants in the contaminated solvent stream to pass the regenerated solvent to the storage unit 320 and pass the contaminants away from the system in conduit 322.

To manage the operations for this system 300, a control system 340 may communicate with a flow regulation device 342 and various measurement devices or sensors, such as sensors 344, 346, and 348, as shown via the dashed lines. The control system 340 may include a processor, memory accessible by the processor and a set of instructions stored on the memory that are configured to communicate with the flow regulation device 342 and sensors 344, 346, and 348 to receive measurement data and provide instructions. The control system may calculate from the measurement data the flow rate of the selective solvent and may communicate with the flow regulation device 342 to adjust or regulate the flow rate of the selective solvent that enters the mixer 310. The control system 340 may adjust the size of one or more openings (e.g., variable sized openings), the numbers of openings, orientation of the blades, dampers and/or baffles to regulate the volume of selective solvent stream entering the mixer 310.

In addition, the control system 340 may communicate with the sensors 344, 346, and 348 to obtain the measurements, such as temperature, pressure and concentration levels of different molecules in the stream. The sensors 344, 346, and 348 may transmit a signal associated with the respective measurement data to the control system 340, which is utilized to adjust the selective solvent flow rate. By way of example, the sensor 344 may be disposed at a location between the inlet separator 304 and the mixer 310 and configured to obtain the measurement data at that location, while the sensor 346 may be disposed to obtain measurement data from within the mixer 310. The sensor 348 may be disposed at a location between the separator 316 and the hydrocarbon storage unit 324 and configured to obtain the measurement data at that location.

As an example, during operation mode, the control system 340 may communicate with the sensors 344, 346 and 348. Based on the measurement data (e.g., temperature data, pressure data or concentration data), the control system 340 may transmit a notification to the flow regulation device 342, which adjusts the volume of selective solvent stream to maintain the removal of the contaminant in the mixed stream in conduit 330 between a first set of user-defined thresholds (e.g., low and high concentration set points). Further, the control system 340 may communicate with the sensors 344 and 346 to obtain temperature data, pressure data and/or concentrations for contaminants, such as H₂S, and to transmit notifications to the control system 340 based on these measurements. Based on the measurements, the control system 340 may determine the proper flow rate for the selective solvent and may transmit a notification to the flow regulation device 342, which adjusts the volume of selective solvent being provide to the mixer 310.

In addition, during start-up, shutdown mode or in an interrupt mode, the sensor 348 may be utilized as part of a recirculation loop 328 to maintain the proper contaminant concentration level in the hydrocarbon storage unit 324. As an example, the control system 340 may communicate with the sensor 348 to obtain concentrations for contaminants, such as H₂S, and to transmit notifications to the control system 340 based on these measurements. If the measurements show elevated H₂S concentrations, the control system 340 may determine that the fluids in the hydrocarbon storage unit 324 should be recirculated through the system to the inlet separator 304. The control system 340 may transmit the notifications to control valves (not shown) to adjust the flow path through the recirculation loop 328 to lessen the contamination in the system.

Further, persons skilled in the technical field will readily recognize that in practical applications of the disclosed methodology, it may partially be performed on a computer or processor-based device, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities (e.g., measuring concentrations, temperatures and pressures along the flow path). Usually, although not necessarily, these quantities take the form of electrical or magnetic signals capable of being stored, transferred, combined, compared, and otherwise manipulated in a computer system.

For example, the control system 340 and the sensors 344, 346 and 348 may be implemented as software, hardware, firmware or any combination of the three. Of course, wherever a component of the present techniques is implemented as software, the component can be implemented as a standalone program (e.g., set of instructions), as part of a larger program, as a plurality of separate programs, as a statically or dynamically linked library, as a kernel loadable module, as a device driver, and/or in every and any other way known now or in the future to those of skill in the art of computer programming. Additionally, the present techniques is in no way limited to implementation in any specific operating system or environment.

Further, one or more embodiments may include methods that are performed by executing one or more sets of instructions to perform the monitoring of the temperatures in various stages of the process. For example, the method may include executing one or more sets of instructions to perform comparisons between thresholds current statuses or indications along with transmitting data between modules, components and/or sensors.

As an example, the control unit may be a computer system, which may be utilized and configured to implement on or more of the present aspects. The computer system may include a processor; memory in communication with the processor; and a set of instructions stored on the memory and accessible by the processor, wherein the set of instructions, when executed, are configured to: receive a transmitted signal from the sensors and regulator; determine a temperature from the transmitted signal; provide one or more of a visual indication and audible notification associated with the temperature, if a change in temperature has occurred; and store the updated status in memory.

Further, as may be appreciated, any number of additional components may be included within the system 300, depending on the details of the specific implementation. For example, the system 300 may include any suitable types of heaters, chillers, condensers, liquid pumps, gas compressors, blowers, bypass lines, other types of separation and/or fractionation equipment, valves, switches, controllers, and pressure-measuring devices, temperature-measuring devices, level-measuring devices, or flow-measuring devices, among others.

For example, the gaseous stream may also be pretreated upstream of the inlet separator 304 with other equipment. For example, the gaseous stream may undergo a water wash to remove glycol or other chemical additives. This may be performed with compact contacting technology equipment or other suitable equipment. The removal of any glycol from the gaseous stream may lessen or control foaming within the equipment downstream of the inlet separator 304. Similarly, as another example, corrosion inhibitors may be added to the gaseous stream or the selective solvent to retard the reaction of O₂ with the steel in the processes for flue gas applications.

FIG. 4 is a diagram of a portion of a selective removal system 400 in accordance with an embodiment of the present techniques. This selective removal system may utilize the compact contacting technology in combination with the selective solvent to enhance the contaminant removal from a gaseous stream. In this system 400, the gaseous stream, which may be a sour natural gas stream, is provided via conduit 402 and may be flowed through various contacting devices, such as contacting devices 404, 406 and 408. The contacting devices 404, 406 and 408 may each include mixing stage, mass transfer stage, and separation stage. In this configuration, the stream initially is passed to a first contacting device 404 that forms a rich solvent stream that is removed via conduit 405 and the remaining gas stream is passed to the second contacting device 406. Finally, the stream from other contacting devices, such as second contacting device 406, may be passed to the final contacting device 408. The output gas stream from final contacting device 408 may be conducted away as the treated gas stream in conduit 409. Semi-lean solvent is recovered and transported via conduit 414 to a flash vessel to desorb some of the acid gases, and increase the solvent's capacity. The flashed liquid is then passed to a pump, which impels the liquid to the previous contacting device (in this configuration the second contacting device 406) via conduit 412. The solvent is depressurized in a flash vessel, and a pump may be utilized to move the flashed liquid to contacting device 404 via conduit 410. Rich solvent is separated and sent to a regeneration unit via conduit 405. The regenerated, cooled solvent is introduced to contacting vessel 408 via conduit 415, thus completing the circuit.

As a specific example, the configuration of a combination of compact contacting technology and tertiary amines (like MDEA) may be modeled using a process simulator. The specific combination enhances selectivity when the rich amine is flashed between co-current stages of the compact contacting technology arranged in a counter-current configuration. The benefit will also be realized if the contacting stage is of the counter-current type. In particular, for a feed gas containing 10,000 ppm of H₂S and 10,000 ppm of CO₂ if the configuration includes one foot of packing (counter current) for a given set of conditions, the remaining H₂S is 3187 parts per million (ppm), while the remaining CO₂ is 9337 ppm. If the stream is split into four 0.25 feet (ft) contactors with interstage flash being performed, the remaining H₂S is 1931 ppm H₂S, and remaining CO₂ is 8926 ppm. As a result, about 70% of the H₂S is removed, but only about 7% of the CO₂ is removed. Thus, while the configuration does not lessen the CO₂ as much as the H₂S, the reduction in H₂S content within the stream is enhanced. In this configuration, the interstage flashing partially unloads the amine, which results in more acid gas removed in each subsequent stages of the compact contacting technology. The slower reaction of CO₂ (hydration, followed by carbonic acid formation) may be more easily reversed under pressure reduction.

In certain configurations, a system for separating H₂S and CO₂ from a gaseous stream may include a compact contacting unit configured to receive a gaseous stream. The compact contacting unit comprises a mixing stage, a mass transfer stage and a separation stage. The mixing stage is configured to mix the gaseous stream with a selective solvent to form a mixed stream, wherein the selective solvent is configured to react with a first contaminant with a first reaction time and to react with a second contaminant with a second reaction time. The mass transfer stage is downstream of the mixing stage and is configured to perform an absorption step for a residence time period, wherein the first reaction time is less than the residence time period, and the second reaction time is greater than the residence time period. The separation stage is downstream of the mass transfer stage and is configured to conduct away a contaminant stream having a portion of the first contaminant from the mixed stream, wherein the remaining mixed stream has a lower concentration of the first contaminant than the mixed stream.

In other configurations, the system may include various enhancements. For example, the system may include a flash unit in fluid communication with the separation stage and configured to remove one of a portion of the first contaminant, a portion of the second contaminant or any combination thereof from the contaminant stream; may include a pump unit downstream of the flash unit and configured to pass the remaining portion or a liquid portion of the flashed contaminant stream to the mixing stage as a portion of the selective solvent; may include a second compact contacting unit downstream of the compact contacting unit and configured to receive the remaining mixed stream, wherein the second compact contacting unit comprises a second mixing stage configured to mix the remaining mixed stream with a second selective solvent to form a second mixed stream, wherein the second selective solvent is configured to react with the first contaminant with the first reaction time and to react with the second contaminant with the second reaction time; a second mass transfer stage downstream of the second mixing stage and configured to perform an absorption step for a second residence time period, wherein the first reaction time is less than the second residence time period, and the second reaction time is greater than the second residence time period; and a second separation stage downstream of the second mass transfer stage and is configured to conduct away a second contaminant stream having a portion of the first contaminant from the second mixed stream, wherein the remaining second mixed stream has a lower concentration of the first contaminant than the second mixed stream. In addition, the system may include a second flash unit in fluid communication with the second separation stage and configured to remove one of a portion of the first contaminant, a portion of the second contaminant or any combination thereof from the second contaminant stream and/or a second pump unit downstream of the second flash unit and configured to pass the remaining portion or liquid portion of the flashed second contaminant stream to the second mixing stage as a portion of the second selective solvent.

In other configurations, the system may include a control system along with one or more sensors and regulators to manage the operation of the process. For example, the system may include a sensor configured to determine a concentration of contaminants in the gaseous stream; a flow regulator configured to adjust the flow rate of the selective solvent; and a control system configured to communicate with the sensor and the flow regulator and to compare the concentration of contaminants to a contaminant threshold; and to transmit an adjustment notification to the flow regulator to adjust the flow rate of the selective solvent based on the comparison, wherein the contaminants comprise one of CO₂, H₂S and any combination thereof. Further, the system may include a sensor configured to determine a measurement of a temperature or a pressure of the gaseous stream; a flow regulator configured to adjust the flow rate of the selective solvent; and a control system configured to communicate with the sensor and the flow regulator and to compare the measurement to a measurement threshold; and to transmit an adjustment notification to the flow regulator to adjust the flow rate of the selective solvent based on the comparison.

In view of the many possible embodiments to which the principles of the disclosed invention may be applied, it should be recognized that the illustrative embodiments are only preferred examples of the invention and should not be taken as limiting the scope of the invention.

What is claimed is:

1. A method for separating H₂S and CO₂ from a gaseous stream, including:
passing a gaseous stream to a compact contacting unit;
mixing the gaseous stream with a selective solvent to form a mixed stream, wherein the selective solvent is configured to react with a first contaminant with a first reaction time and to react with a second contaminant with a second reaction time;
performing an absorption step for a residence time period, wherein the first reaction time is less than the residence time period, and the second reaction time is greater than the residence time period;
conducting away a contaminant stream having a portion of the first contaminant from the mixed stream, wherein the remaining mixed stream has a lower concentration of the first contaminant than the mixed stream; and
removing the first contaminant from the process.

2. The method of claim 1, further comprising:
determining a concentration of CO₂ in the gaseous stream;
comparing the concentration of CO₂ to a CO₂ threshold; and
adjusting the flow rate of the selective solvent based on the comparison.

3. The method of claim 1, further comprising:
determining a concentration of H₂S in the gaseous stream;
comparing the concentration of H₂S to a H₂S threshold; and
adjusting the flow rate of the selective solvent based on the comparison.

4. The method of claim 1, further comprising:
measuring a temperature of the gaseous stream; and
adjusting the flow rate of the selective solvent based on the measured temperature.

5. The method of claim 1, further comprising:
measuring a pressure of the gaseous stream; and
adjusting the flow rate of the selective solvent based on the measured pressure.

6. The method of claim 1, wherein the selective solvent has kinetic differences in the absorption reactions for CO₂ and H₂S in a range between 10 and 1000 times, with the H₂S reaction being faster than the CO₂ reaction.

7. The method of claim 1, wherein the residence time is managed to lessen any displacement of the H₂S molecules by CO₂ molecules.

8. The method of claim 1, further comprising flashing the contaminant stream to remove one of a portion of the first contaminant, a portion of the second contaminant, or any combination thereof.

9. The method of claim 8, wherein a liquid portion of the flashed contaminant stream is cycled to the next mixing step as a portion of the selective solvent.

10. The method of claim 1, further comprising:
mixing the remaining mixed gaseous stream with a second selective solvent to form a second mixed stream, wherein the second selective solvent is configured to react with the first contaminant with the first reaction time and to react with the second contaminant with the second reaction time;
performing an absorption step for a second residence time period, wherein the first reaction time is less than the second residence time period, and the second reaction time is greater than the second residence time period;
conducting away a second contaminant stream having a portion of the first contaminant from the second mixed stream, wherein the remaining second mixed stream has a lower concentration of the first contaminant than the initial second mixed stream.

11. The method of claim 10, further comprising flashing the second contaminant stream to remove one of a portion of the first contaminant, a portion of the second contaminant or any combination thereof.

12. The method of claim 11, wherein a liquid portion of the flashed second contaminant stream is cycled to the next mixing step as a portion of the second selective solvent.

13. The method of claim 1, wherein the selective solvent is a tertiary amine.

14. The method of claim 13, wherein the tertiary amine is methyldiethanolamine.

15. The method of claim 1, wherein the selective solvent is one of a formulated amine and a sterically-hindered amine.

16. A system for separating H₂S and CO₂ from a gaseous stream, comprising:
a compact contacting unit configured to receive a gaseous stream, wherein the compact contacting unit comprises:
a mixing stage configured to mix the gaseous stream with a selective solvent to form a mixed stream, wherein the selective solvent is configured to react with a first contaminant with a first reaction time and to react with a second contaminant with a second reaction time;
a mass transfer stage downstream of the mixing stage and configured to perform an absorption step for a residence time period, wherein the first reaction time is less than the residence time period, and the second reaction time is greater than the residence time period; and
a separation stage downstream of the mass transfer stage and configured to conduct away a contaminant stream having a portion of the first contaminant from the mixed stream, wherein the remaining mixed stream has a lower concentration of the first contaminant than the mixed stream.

17. The system of claim 16, further comprising a flash unit in fluid communication with the separation stage and configured to remove one of a portion of the first contaminant, a portion of the second contaminant or any combination thereof from the contaminant stream.

18. The system of claim 17, further comprising a pump unit downstream of the flash unit and configured to pass a liquid portion of the flashed contaminant stream to the mixing stage as a portion of the selective solvent.

19. The system of claim 16, further comprising:
a second compact contacting unit downstream of the compact contacting unit and configured to receive the remaining mixed stream, wherein the second compact contacting unit comprises
a second mixing stage configured to mix the remaining mixed stream with a second selective solvent to form a second mixed stream, wherein the second selective solvent is configured to react with the first contaminant with the first reaction time and to react with the second contaminant with the second reaction time;
a second mass transfer stage downstream of the second mixing stage and configured to perform an absorption step for a second residence time period, wherein the first reaction time is less than the second residence time period, and the second reaction time is greater than the second residence time period; and
a second separation stage downstream of the second mass transfer stage and is configured to conduct away a second contaminant stream having a portion of the first contaminant from the second mixed stream, wherein the remaining second mixed stream has a lower concentration of the first contaminant than the second mixed stream.

20. The system of claim 19, further comprising a second flash unit in fluid communication with the second separation stage and configured to remove one of a portion of the first contaminant, a portion of the second contaminant or any combination thereof from the second contaminant stream.

21. The system of claim 20, further comprising a second pump unit downstream of the second flash unit and configured to pass a liquid portion of the flashed second contaminant stream to the second mixing stage as a portion of the second selective solvent.

22. The system of claim 16, further comprising:
a sensor configured to determine a concentration of contaminants in the gaseous stream, wherein the contaminants comprise one of CO₂, H₂S and any combination thereof;
a flow regulator configured to adjust the flow rate of the selective solvent; and
a control system configured to communicate with the sensor and the flow regulator and to compare the concentration of contaminants to a contaminant threshold; and to transmit an adjustment notification to the flow regulator to adjust the flow rate of the selective solvent based on the comparison.

23. The system of claim 16, further comprising:
a sensor configured to determine a measurement of a temperature or a pressure of the gaseous stream;
a flow regulator configured to adjust the flow rate of the selective solvent; and
a control system configured to communicate with the sensor and the flow regulator and to compare the measurement to a measurement threshold; and to transmit an adjustment notification to the flow regulator to adjust the flow rate of the selective solvent based on the comparison.
